(19) United States
(12) Patent Application Publication
(10) Pub. No.: US 2004/0109314 A1
(43) Pub. Date: Jun. 10, 2004

(54) Backlight module

(76) Inventor: Pang-Lun Yang, Taichung (TW)

Correspondence Address: QUINTERO LAW OFFICE, 1617 BROADWAY, 3RD FLOOR, SANTA MONICA, CA, 90404, US

(21) Appl. No.: 10/726,473

(22) Filed: Dec. 3, 2003

(30) Foreign Application Priority Data
Dec. 10, 2002 (TW) 91135708

(51) Int. Cl. F21V 13/04

(52) U.S. Cl. 362/245; 362/246; 362/247; 362/308; 362/225

(57) ABSTRACT

A backlight module. The module includes a light guide plate, a reflecting plate and multiple lamps, wherein the light guide plate has a first surface and a second surface opposite each other. The light guide plate has a plurality of grooves on the second surface, each of which is arranged corresponding to one of the lamps. Light is emitted by the lamps, reflected by the reflecting plate, reaches the light guide plate through the second surface, and exits from the first surface.

### BACKGROUND OF THE INVENTION

1. Field of the Invention

The present invention relates to a backlight module for a liquid crystal display (LCD).

2. Description of the Related Art

FIG. 1A is a perspective view showing a typical direct type backlight device of a LCD. In FIG. 1A, the backlight device 10 includes a light guide plate 11, a reflecting plate 12, and a plurality of lamps 13, wherein the lamps 13 are disposed between the reflecting plate 12 and the light guide plate 11.

Generally, the brightness of the light guide plate 11 is high when one lamp 13 is positioned underneath the light guide plate 11. In addition, the brightness of the light guide plate 11 is low when no lamp is positioned under the light guide plate 11. Therefore, strips having bright lines and dark lines are formed on the liquid crystal panel.

To overcome the above-mentioned problem, as shown in FIG. 1B, another backlight device is shown. In order to reduce the bright lines, several shielding sheets 24 are formed on the surface of the light guide plate 21 with respect to the lamps 23 so that the shielding sheets 24 can shield the bright lines. However, the final brightness of the liquid crystal panel will be reduced, too.

FIG. 1C shows another backlight device of an LCD. There are several v-shaped regions formed on the reflecting plate 32. Each v-shaped region is positioned according to each lamp 33 in order to reflect light from the lamp 33 so that the difference between the bright and dark lines on the light guide plate 31 can be reduced. However, dark lines are still formed between the V-shaped regions and light lines are still formed above the V-shaped regions because light of the lamps 33 will directly pass through the light guide plate 32.

### SUMMARY OF THE INVENTION

Accordingly, an object of the invention is to provide a backlight module including a light guide plate, a reflecting plate and a plurality of light sources. The light guide plate has a first surface and a second surface opposite the first surface. The light guide plate has a plurality of grooves on the second surface, each of which is arranged corresponding to one of the light sources. Light is emitted by the light sources, reflected by the reflecting plate, enters the light guide plate through the second surface, and exits from the first surface.

In the present invention, a cross-sectional shape of each of the grooves is substantially in an arc shape, a triangular shape, a rectangular shape, or a polygonal shape.

According to the present invention, the second surface of the light guide plate is uneven, the incident angles of lights are varied, so the second surface of the light guide plate uniformly transmits light emitted from the light source to the first surface of the light guide plate. Furthermore, light sources can be embedded in the grooves of the light guide plate so as to reduce the thickness of the direct backlight module.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a perspective view showing a conventional backlight device of a LCD;

FIG. 1B is a cross-sectional drawing of the backlight device of FIG. 1A;

FIG. 1C is a cross-sectional drawing of another backlight device of the related art;

FIG. 2 is a cross-sectional drawing of a first embodiment in the present invention;

FIG. 3 is a cross-sectional drawing of a second embodiment in the present invention; and

FIG. 4 is a cross-sectional drawing of a third embodiment in the present invention.

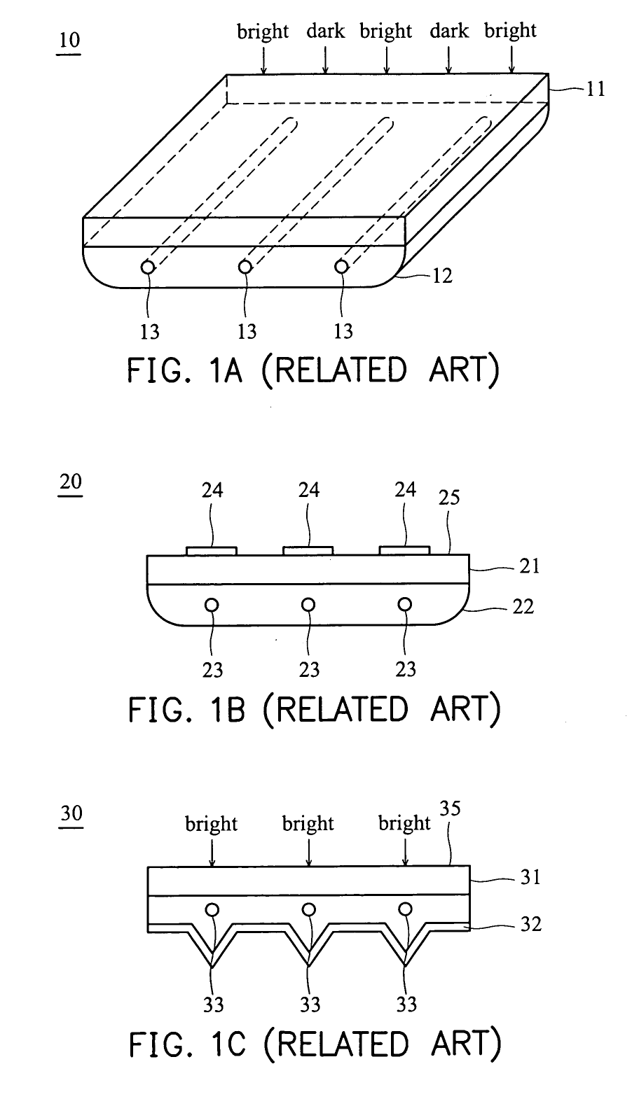

### DETAILED DESCRIPTION OF THE INVENTION

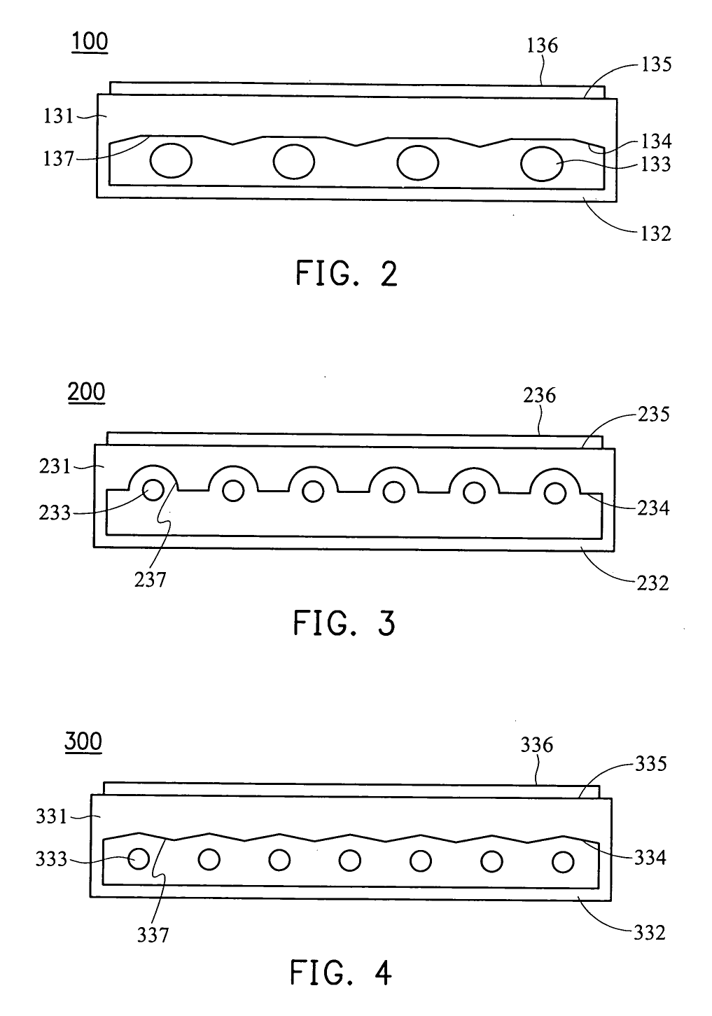

FIG. 2 is a cross-sectional drawing of a first embodiment in the present invention. In this embodiment, the backlight module 100 is a direct type backlight module 100, and includes a light guide plate 131, a reflecting plate 132, and a plurality of lamps 133.

The light guide plate 131 has a first surface 135 and a second surface 134 opposite to each other. A plurality of grooves 137 are formed on the second surface 134. The lamps 133 are disposed between the light guide plate 131 and the reflecting plate 132. Each lamp 133 is positioned corresponding to each groove 137. Therefore, the lamps 133 are embedded in the grooves 137 of the light guide plate 131 to reduce the thickness of the direct backlight module 100.

Light emitted by the lamps 133 directly reaches the light guide plate 131 can pass through the second surface 134 with the grooves 137, and exits the light guide plate 131 from the first surface 135. In addition, light emitted by the lamps 133 is also reflected by the reflecting plate 132 and enter the light guide plate 131 later. Therefore, the lamps 133 can produce uniform lights on the light guide plate, and the strips having bright and dark regions can be eliminated.

The cross-sectional shapes of the grooves 137 are polygons, as shown in FIG. 2. Furthermore, a light-diffusing device 136 is disposed on the light guide plate 131 to enhance the uniformity of the light. The light-diffusing device 136 includes a protecting film, a prism sheet, and a diffusing sheet disposed on the light guide light 131.

FIGS. 3 and 4 show a second and a third embodiment of the present invention respectively, while the structures of backlight modules in the second and third embodiments are similar to that of the first embodiment.

The differences among these three embodiments are the cross-sectional shapes of the grooves 137, 237, and 337. In the second embodiment, as shown in FIG. 3, the backlight module 200 has a light guide plate 231, a reflecting plate 232, a plurality of lamps 233, and a light-diffusing device 236. The light guide plate 231 has a first surface 235 and a second surface 234 with a plurality of grooves 237. The arced groove 237 is the major difference between the first and the second embodiment. In the third embodiment, as shown in FIG. 4, the backlight module 300 also includes a light guide plate 331, a reflecting plate 332, a plurality of lamps 333, and a light-diffusing device 336. The light guide plate 131 has a first surface 335 and a second surface 334 with plurality of grooves 337. The triangular shaped groove 337 is the major difference between the first and the third embodiments.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a light guide plate having a first surface and a second surface opposite each other and defining a plurality of grooves on the second surface;
a reflecting plate; and
a plurality of light sources disposed between the light guide plate and the reflecting plate, each light source being positioned corresponding to each groove, wherein light is emitted by the light sources, reflected by the reflecting plate, reaches the light guide plate through the second surface, and exits the light guide plate from the first surface.

2. The module as claimed in claim 1, wherein a cross-sectional shape of each of the grooves is substantially in an arc shape.

3. The module as claimed in claim 1, wherein a cross-sectional shape of each of the grooves is substantially in a triangular shape.

4. The module as claimed in claim 1, wherein a cross-sectional shape of each of the grooves is substantially in a rectangular shape.

5. The module as claimed in claim 1, wherein a cross-sectional shape of each of the grooves is substantially in a polygonal shape.

6. The module as claimed in claim 1, further comprising:
a protecting film disposed on the first surface;
a prism sheet disposed on the protecting film; and
a diffusing sheet disposed on the prism sheet.

7. The module as claimed in claim 1, wherein the light sources are lamps.
